(19) United States
(12) Patent Application Publication
(10) Pub. No.: US 2006/0120026 A1
(43) Pub. Date: Jun. 8, 2006

(54) Modular arrangement of components of electrical equipment enclosure

(75) Inventors: Jason P. Wiant, Bedford, TX (US); Harry W. Josten, Grapevine, TX (US); Robert D. Meyer, Arlington, TX (US); Russell J. Wedemeyer, Colleyville, TX (US)

Correspondence Address: FOLEY & LARDNER LLP, 777 EAST WISCONSIN AVENUE, SUITE 3800, MILWAUKEE, WI, 53202-5308, US

(73) Assignee: Siemens Corporation

(21) Appl. No.: 11/007,632

(22) Filed: Dec. 8, 2004

(51) Int. Cl. H02B 13/02

(52) U.S. Cl. 361/614

(57) ABSTRACT

A method and an arrangement of components in a switchgear enclosure having multi-phase electrical power run-in and run-back bus bars. The circuit breaker is also provided in the enclosure. The arrangement of components is configured to provide interchangeable modularity of components within the enclosure. The arrangement of components includes a run-in mounting base including a primary disconnect member for each electrical phase. A run-back mounting base, including a primary disconnect member for each electrical phase is also included. The run-in mounting base and the run-back mounting base are configured to interchange the line and load side of the circuit breaker. Another embodiment of the arrangement includes a bridge coupled to one of the run-in mounting base and run-back mounting base, with the bridge configured to position each primary disconnect member for alignment with the circuit breaker. 136

### FIELD

The present invention generally relates to the field of electrical switchboards and panel boards, and more particularly to a modular arrangement of components of an electrical equipment enclosure having multi-phase electrical power bus bars.

### BACKGROUND

Switchgear assemblies and switchboards and panel boards are general terms which cover metal enclosures, housing switching and interrupting devices such as fuses and circuit breakers, along with associated control, instrumentation and metering devices. Such assemblies typically include associated bus bars, interconnections and supporting structures used for the distribution of electrical power. Low voltage switchgear and switchboards operate at voltages of up to 600 volts and with continuous currents up to 5000 amps or higher. Such devices are also designed to withstand short circuit currents ranging up to 200,000 amps (3 phase RMS symmetrical).

Typical switchgear equipment is composed of a lineup of several metal enclosed sections. Each section may have several circuit breakers stacked one above the other vertically in the front of the section with each breaker being enclosed in its own metal compartment. Each section has a vertical or section bus which supplies current to the breakers within the section by short horizontal branch busses, also referred to as run-in busses. The vertical bus bars in each section are supplied with current by a horizontal main bus bar that runs through the lineup of metal enclosed sections. A typical arrangement includes bus bars for each electrical phase of a multi-phase system which may include three power phases and a neutral.

Circuit breakers used in switchgear enclosures may be of a stationary or a draw out construction. In a stationary construction, the circuit breaker is bolted to the structure both mechanically and electrically and is not removable without the use of tools. A draw out construction of a circuit breaker typically is removable without the use of tools. However, draw out breakers use plug-in electrical connections to the switchgear bus, generally referred to as primary disconnects, and are located at the rear wall of the circuit breaker compartment. In addition, the circuit breaker may have plug-in connections for control and communication wiring typically called secondary disconnects. In order to function properly, the draw out circuit breaker must rack in and out of the circuit breaker compartment without binding and with proper alignment of the primary and secondary disconnects to insure proper engagement for good electrical connection.

Known primary disconnects for electrical equipment, particularly circuit breakers typically are not replaceable from inside the breaker compartment. Access to change out or repair primary disconnects in prior art patents require access from the rear of the equipment and may require extensive disassembly of equipment and components within the enclosure. Known methods of alignment of primary disconnects include the use of a stab positioning system, however, such system typically requires rear access to secure the disconnect with a bolt. Additionally, careful alignment of the primary disconnects is required to ensure proper engagement with the circuit breaker and to prevent separation during a short circuit condition. Such procedures require special tooling and additional time with the overall system down.

Thus there is a need for an arrangement of components in an electrical equipment enclosure that provides access to the primary disconnects from the front of the enclosure and without extensive disassembly. There is further need for a modular (standard) arrangement of components to accommodate different equipment applications. There is an additional need for an arrangement of components for primary disconnect installation, servicing, replacement and maintenance with access from the front of the enclosure with common tools and without the need for subsequent alignment checking.

### SUMMARY OF THE INVENTION

There is provided an arrangement of components in a switchgear enclosure having multi-phase electrical power run-in and run-back bus bars. The circuit breaker is also provided in the enclosure. The arrangement of components is configured to provide interchangeable modularity of components within the enclosure. The arrangement of components includes a run-in mounting base including a primary disconnect member for each electrical phase. A run-back mounting base, including a primary disconnect member for each electrical phase is also included. The run-in mounting base and the run-back mounting base are configured to interchange the line and load side of the circuit breaker. Another embodiment of the arrangement includes a bridge coupled to one of the run-in mounting base and run-back mounting base, with the bridge configured to position each primary disconnect member for alignment with the circuit breaker.

There is also provided a method for assembling and maintaining a primary disconnect in a switchgear enclosure having a circuit breaker mounting base and one of a run-back bus bar and run-in bus bar mounted through an orifice in the mounting base. The method comprises the steps of providing a-mounting base with alignment notches. Providing a bridge having at least one alignment tab configured to engage the alignment notch and mounting the bridge in the alignment notch. Providing a primary disconnect bus. Positioning the primary disconnect bus against the alignment bridge to align the primary disconnect bus front to back and adjacent to the run-back bus bar or run-in bus bar to align the primary disconnect bus side-to-side. Connecting the primary disconnect bus to the run-back bus bar or run-in bus bar with a fastener to align the primary disconnect bus top to bottom. The assembly and maintenance of the primary disconnect is performed at the front of the switchgear enclosure. Another embodiment includes performing the same method for each run-back bus bar or run-in bus bar of each phase in the mounting phase.

There is also provided a method for assembling and maintaining a primary disconnect and a switchgear enclosure having a circuit breaker mounting base and one of a run-back bus bar and run-in bus bar mounted through an orifice in the mounting base. The method comprises the steps of providing alignment ribs in the mounting base. Providing a primary disconnect bus, with the primary disconnect bus having two branches and defining rib notches. Positioning the primary disconnect bus and the mounting-base to align the primary disconnect bus front to back and adjacent to the run-back bus bars or run-in bus bars to align the primary disconnect bus side-to-side. Engaging the alignment ribs with the rib notches in the primary disconnect bus. Connecting the primary disconnect bus to the run-back bus bar or run-in bus bar with a fastener to align the primary disconnect bus top to bottom. The assembly and maintenance of the primary disconnect bus is performed at the front of the switchgear enclosure. Another embodiment of the method includes coupling each run-back bus bar or run-in bus bar of each phase in the mounting base.

### BRIEF DESCRIPTION OF THE DRAWINGS

FIG. 1 is a perspective view of an electrical equipment enclosure including compartments for electrical equipment such as the circuit breaker, and including horizontal and vertical bus bars.

FIG. 2 is a perspective view of an electrical equipment enclosure from the rear aspect of the enclosure illustrated in FIG. 1 with side covers and rear doors removed for clarity. The horizontal main bus, horizontal-to-vertical bus connectors, vertical section bus, vertical bus braces run-in bus bars and run-back bus bars are visible.

FIG. 3 is a partial top view of the circuit breaker coupled to a run-in mounting base coupled to vertical bus bars with run-in bus bars. An exemplary embodiment of a bridge positioning a primary disconnect member and each electrical phase is illustrated.

FIG. 4 is a partial top view of a circuit breaker coupled to a run-back mounting base and coupled to run-back bus bars in each electrical phase in the enclosure. An exemplary embodiment of a bridge aligning the primary disconnect member, in each electrical phase, is also illustrated.

FIG. 5 is a partial top view of a circuit breaker coupled to a run-in mounting base and coupled to vertical bus bars by run-in bus bars in each electrical phase in the enclosure. The primary disconnect member includes two branches in each electrical phase.

FIG. 6 is a perspective view of an exemplary embodiment of a run-in mounting base. The figure also illustrates the installation of an exemplary embodiment of a bridge being installed in the right side phase compartment of the base. An exemplary embodiment of a primary disconnect member is illustrated in the middle phase compartment and butted against the bridge to align the primary disconnect member. The left face compartment illustrates a primary disconnect member mounted and coupled to a run-in bus bar with fasteners for an up and down alignment.

FIG. 7 is a perspective view of an exemplary embodiment of a run-back mounting base coupled to run-back bus bars.

FIG. 8A is a perspective view of the run-in mounting base illustrated in FIG. 5 in illustrating exemplary embodiments of alignment ribs in the mounting base and alignment notches in a primary disconnect member.

FIG. 8B is a rear view of the primary disconnect member used with the run-in mounting base illustrated in FIG. 8A.

FIG. 9 is a side plan view of a circuit breaker coupled to a run-in mounting base and a run-back mounting base and coupled to the vertical and horizontal bus bars in an electrical equipment enclosure.

FIG. 10 is a plan side view of a circuit breaker coupled to a run-back mounting base and run-in mounting base and coupled to the vertical and horizontal bus bars in an electrical equipment enclosure and further illustrating the interchange of the line and load side connections to the breaker by interchanging the modular run-in mounting base and run-back mounting base.

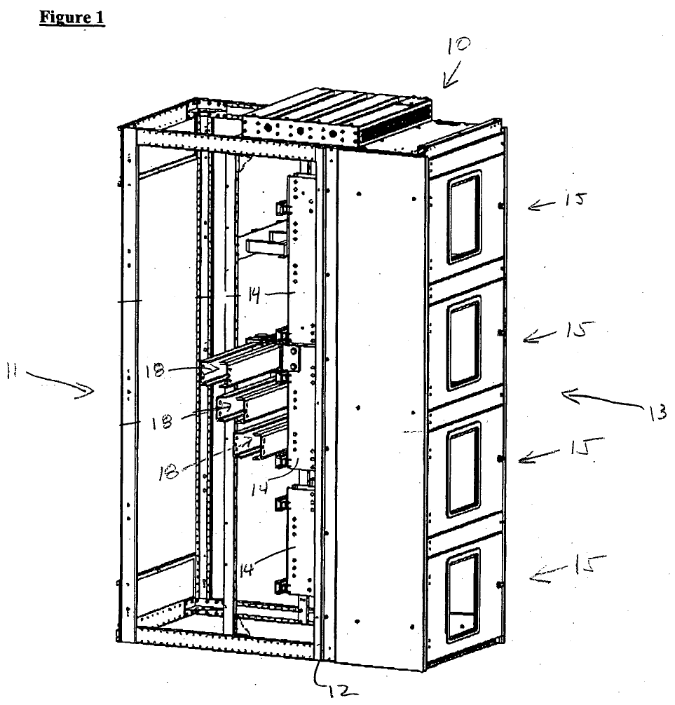

### DETAILED DESCRIPTION OF EXEMPLARY EMBODIMENTS

Before describing the exemplary embodiments of an arrangement of components 25 in an electrical equipment enclosure 10, for example, a switchgear enclosure, having multiple-phase (A, B, C) electrical power run-in bus bars 20 and run-back bus bars 19, several comments are appropriate. Switchgear assemblies and panel board assemblies typically include vertical (section) bus bars to distribute electrical power within the enclosure. In a short circuit condition, extreme magnetic forces are created in the bus bars as a result of short circuit currents up to and including 200,000 amps symmetrical RMS flowing through each bus bar. For a low voltage switchgear and switch boards operating at voltages up to 600 volts and continuous currents that can exceed 5,000 amps. In a three phase power system (typically) as a short circuit current flows through such bus bars, magnetic forces between adjacent bus bars tend to move such bus bars laterally (perpendicular) to the current flow. The circuit breakers when installed in the electrical equipment enclosures to react to short circuit conditions and open the circuits to minimize damage to the enclosure and related electrical equipment. At times it may be desireable to reverse the line and load connections allowing the direction of normal power flow through the circuit breaker to be optimally set. The ability to reverse the line and load connections also eliminates the need to provide reversed feed breakers in the enclosure 10. Standardizing a modular system for the arrangement of components 25 maximizes the flexibility of the electrical equipment enclosure 10 design and use. From a manufacturing standpoint, having common parts and assemblies facilitates custom circuit breaker arrangements and provides ease of design of such systems.

One type of circuit breaker is typically used in electrical equipment enclosures 10 is referred to as a draw-out circuit breaker. The draw-out circuit breaker typically has plug-in electrical connections to bus bars in the enclosure and are typically referred to as primary disconnects. The primary disconnects are located on the rear wall of the circuit breaker compartment. Additional control wiring and communication wiring plug-in connections may also be provided and are referred to as secondary disconnects.

A draw-out circuit breaker compartment typically includes guide rails and a circuit breaker cradle to orientate the circuit breaker between the disconnect, test and connection positions. The circuit breaker compartments may also have additional features such as shutters and interlocks. One type of circuit breaker can be used with the arrangement of components disclosed in here is a circuit breaker referred to as FS2 (frame size 2) rated at 800 amps to 3200 amps manufactured and distributed by Siemens Corporation. Another type of circuit breaker that can be utilized with the arrangement of components 25 disclosed in here is model number FS3 (frame size 3) rated at 3200 amps to 5000 amps also manufactured and distributed by Siemens Corporation.

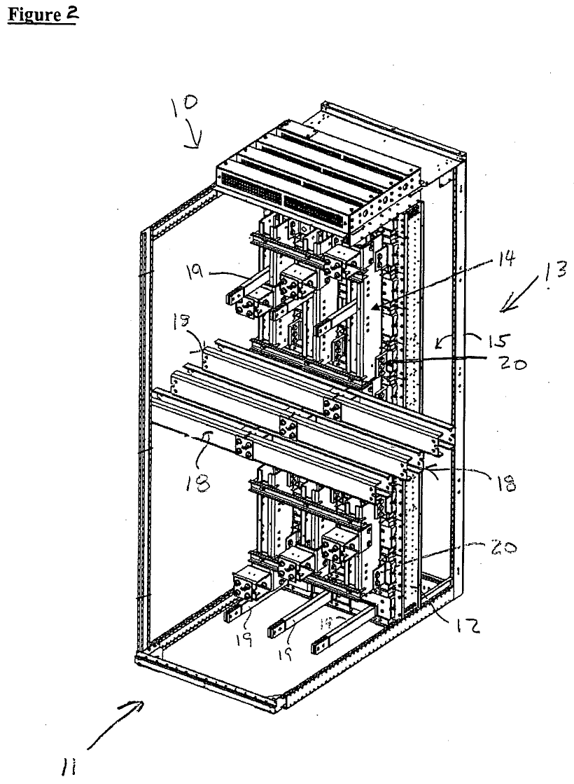

One embodiment of the arrangement of components 25 provides for a series of mounting bases configured to stack one above the other in the enclosure 10. A typical configuration is to mount the mounting base to frame members 12 of the enclosure 10 (see FIGS. 2, 9 and 10).

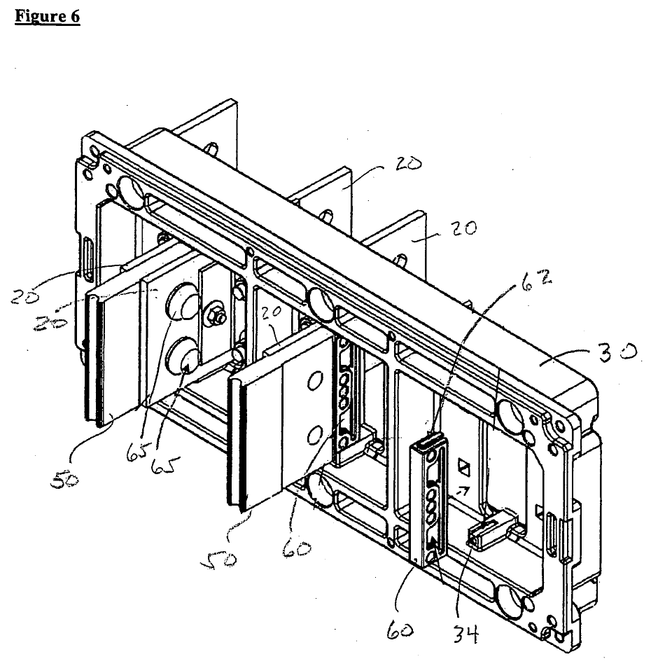

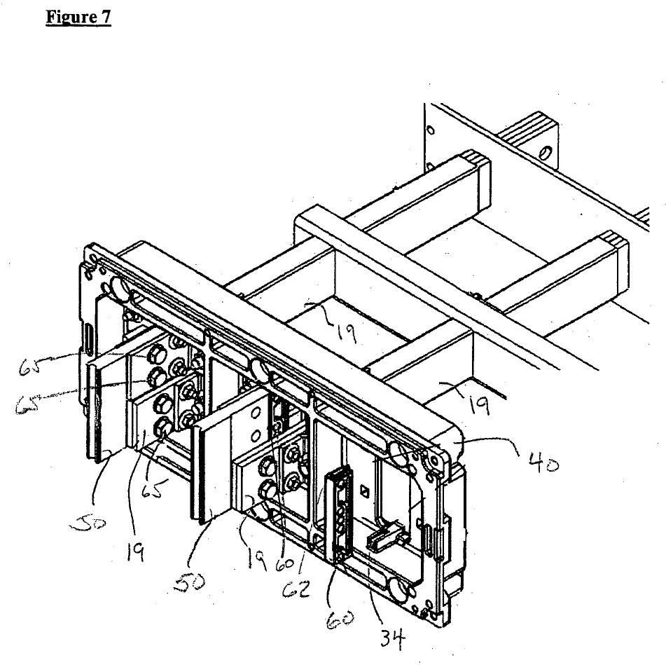

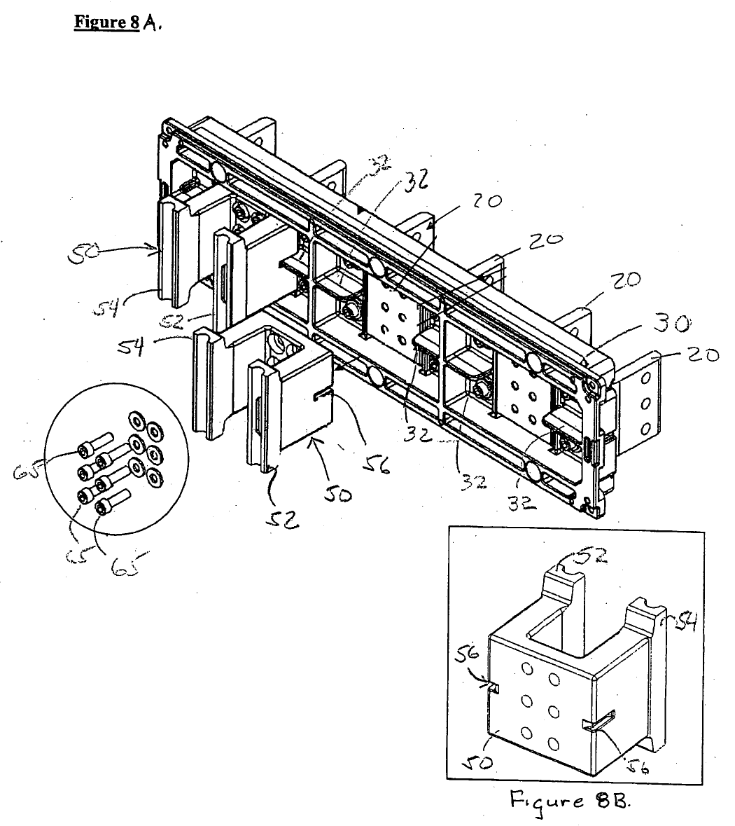

An exemplary embodiment of a run-in mounting base 30 is illustrated in FIG. 6. Another embodiment of a run-in mounting base 30 is illustrated in FIG. 8A. An exemplary embodiment of a run-back mounting base 40 is illustrated in FIG. 7. A detailed description and application of such mounting bases 30, 40, will be explained below.

The electrical equipment enclosure 10 includes a system of horizontal bus bars 18 and vertical bus bars 14 which distribute electric power through and to the various components in the enclosure 10. Typically, the horizontal bus bars 18 provide the main power to the enclosure 10 with the vertical bus bars 14 distributing the power to the selected components. Appropriate couplings between the vertical 14 and horizontal 18 bus bars maximize the power distribution within the enclosure 10. Run-in bus bars 20 provide power to the circuit breaker CB and run-back bus bars 19 move the power from the circuit breaker as illustrated in FIGS. 2-5 and FIGS. 9 and 10.

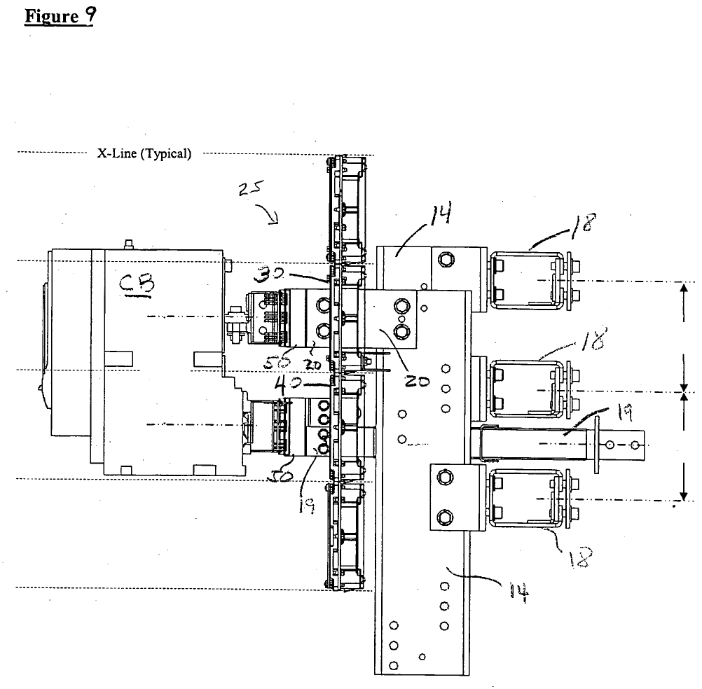

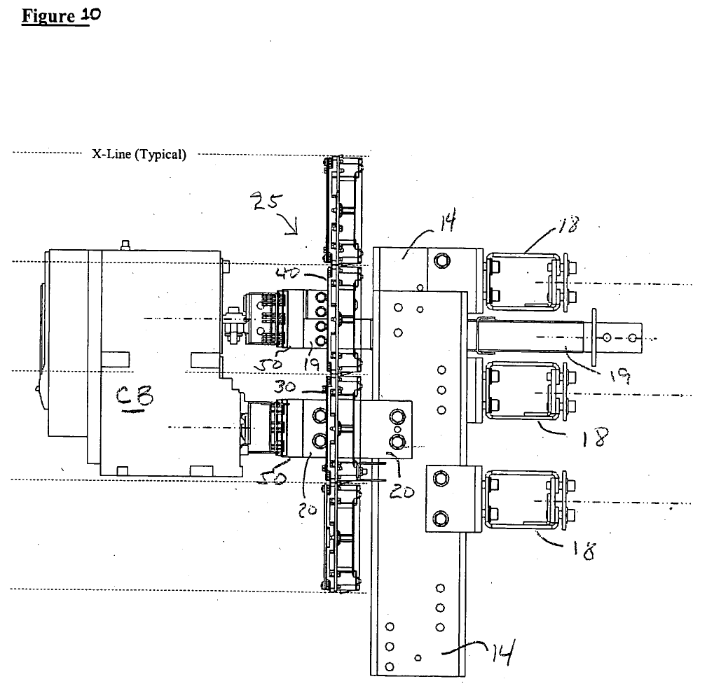

An exemplary embodiment of an arrangement of components as illustrated in FIGS. 9 and 10. In FIG. 9, four mounting bases including one each of a run-in mounting base 30 and a run-back mounting base 40 are illustrated. A circuit breaker CB is coupled to the run-in bus bars 20 and run-back bus bars 19 through a primary disconnect member 50 described below. In FIG. 9, the run-in mounting base 30 is in the second position illustrated and the run-back mounting base 40 is in the third position illustrated. It should be noted that the line-to-load spacing of the circuit breaker primary disconnects for all circuit breaker frame sizes corresponds to the dimensional spacing of the several mounting bases 30, 40 and the horizontal bus bar 18 spacing.

FIG. 10 illustrates a circuit breaker similar to the circuit breaker illustrated in FIG. 9 with the circuit breaker coupled to an arrangement of components 25 being mounting bases 30,40. However, in FIG. 10, the run-back mounting base 40 is in the second position and the run-in mounting base 30 is in the third position. FIGS. 9 and 10 illustrate the interchangeability of the line and load side connections to the circuit breaker facilitated by the arrangement of components 25 disclosed herein.

A run-in mounting base 30 is typically configured to accommodate three electrical phases A, B, C of an electrical power system (see FIG. 6). The run-in mounting base 30 includes a primary disconnect member 50 for each electrical phase. The alignment and positioning of the primary disconnect member 50 is facilitated by a bridge 60 which is inserted into the mounting base 30. An alignment notch is defined in the mounting base and an alignment tab 62 is configured in the bridge. The bridge alignment tab engages the mounting base alignment notches 34 to position the bridge 60 in the mounting base 30. The dimensions of the bridge 60 are such that they will provide a reference or index for positioning the primary disconnect member 50 as part of the arrangement of components 25 in the enclosure 10. In FIG. 6, the right side position of the run-in mounting base 30 illustrates a bridge 60 being moved into position and the mounting base. The middle position of the run-in mounting base 30 illustrates a primary disconnect member 50 positioned against the bridge 60 and adjacent to a run-in bus bar 20. The far left position in the run-in mounting base 30 illustrates a primary disconnect member 50 positioned in the run-in mounting base 30 and sandwiched between two run-in bus bars 20 and secured together with fasteners 65, for example, bolts.

The run-in mounting base 30 can be composed of an insulating material such as a glass reinforced polyester. The bridge may also be made from a glass reinforced polyester but the bridge may also be made from any rigid material including metal since the bridge 60 does not provide electrical insulation.

The primary disconnect member is inserted into the run-in mounting base 30 until the rear surface of the primary disconnect 50 is in contact with the front surface of the bridge 60. The primary disconnect member 50 is releasably secured to the run-in bus bar 20 by fasteners. The front-to-back alignment of the primary disconnect member 50 is set by the bridge and the horizontal or side-to-side alignment is set by the thickness of the bridge 60 and the run-in bus bars 20 on either side of the primary disconnect member 50. The vertical, or up and down alignment, of the primary disconnect member 50 is set by the alignment of the fasteners 65.

The primary disconnect member 50 can be composed of a material such as copper or aluminum. The primary disconnect member 50 can also be a silver plated copper.

The installation of the primary disconnect member 50 or the replacement of the primary disconnect member 50 can be accomplished without any additional measuring or alignment because of the arrangement of the components 25 in the run-in mounting base 30.

A run-back mounting base 40 is illustrated in FIG. 7. In the run-back mounting base 40, a bridge 60 is also used align a primary disconnect member 50 in the run-back mounting base 40. The primary disconnect member 50 is configured similarly to the primary disconnect member 50 used with the run-in mounting base 30. The primary disconnect member 50 is inserted into the run-back mounting base 40 until the rear surface of the primary disconnect 50 is in contact with the front surface of the bridge 60. Run-back bus bars 19 sandwich the primary disconnect member 50 between them as illustrated in FIG. 7.

The run-back mounting base 40 can be composed of the material of glass reinforced polyester. It should be understood that the mounting bases 30, 40 can be composed of any other molded, insulating material, such as thermoplastic or other thermoset material that is appropriate for the intended use.

An alternative embodiment of a run-in mounting base is illustrated in FIG. 8A. In the run-in mounting base 30 illustrated, alignment ribs 32 are configured in the mounting base 30 to align and position a primary disconnect member 50 in each of the electrical phases in the mounting base 30. In FIG. 8A, the primary disconnect member 50 includes a first branch 52 and a second branch 54 and further defines rib notches 56 on the back side of the primary disconnect member 50. The rib notches 56 are aligned and engage the alignment ribs 32 formed in the run-in mounting base 30. The primary disconnect member 50 is coupled to the run-in bus bar 20 with a plurality of fasteners 65 such as bolts.

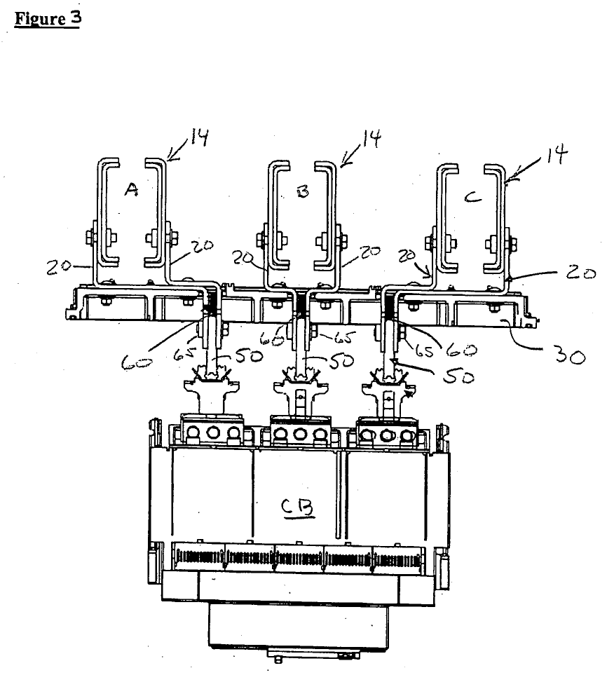

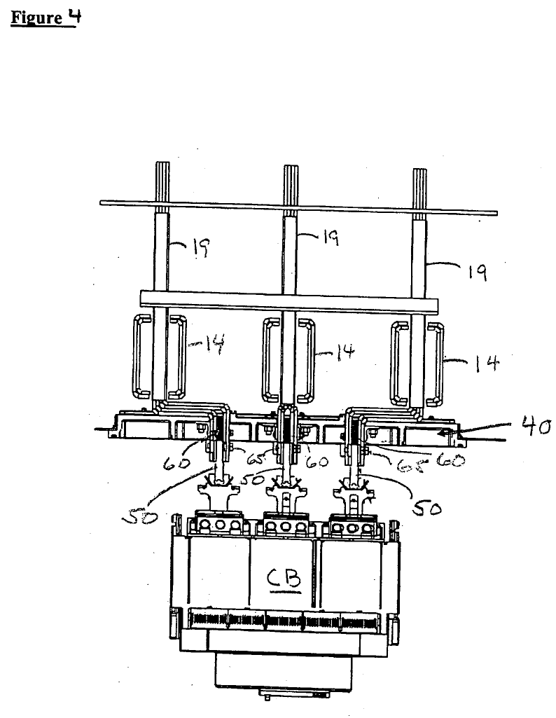

The run-in mounting base 30 illustrated in FIG. 6 is also illustrated in FIG. 3. In FIG. 3, the run-in mounting base 30 includes a primary disconnect member 50 in each of the electrical phases and positioned by a bridge 60 and between two run-in bus bars 20. The run-back mounting base 40 illustrated in FIG. 7 is also illustrated in FIG. 4 illustrating a primary disconnect member 50 in each electrical phase positioned between run-back bus bars 19 and positioned by a bridge 60.

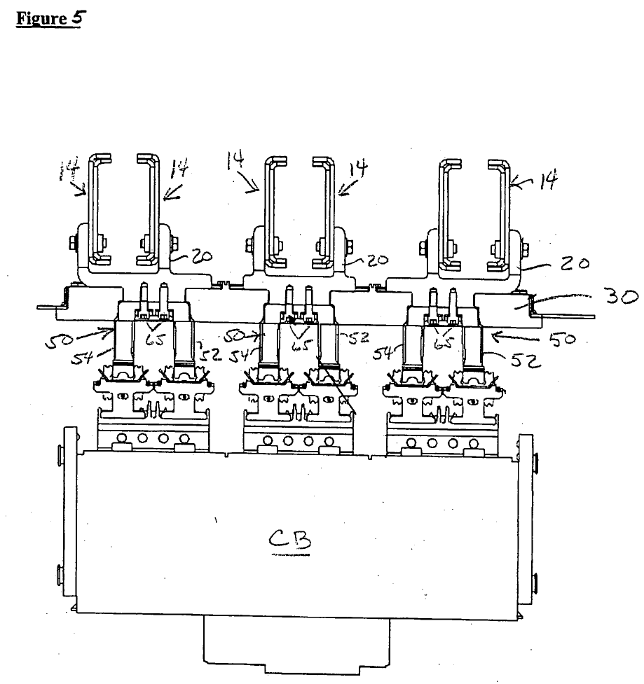

The run-in mounting base illustrated in FIG. 8A is also illustrated in FIG. 5 which also illustrates a primary disconnect member 50 having a first branch 52 and a second branch 54 coupled to each electrical phase in the run-in mounting base. Each primary disconnect member 50 is coupled to a circuit breaker and to a run-in bus bar.

The arrangement of components 25 as described herein allows the installation, servicing and replacement and maintenance of the primary disconnect members 50 with access from the front of the enclosure 10 with the use of common tools and without the need for subsequent alignment checking. The speed of assembly during manufacturing reduces assembly costs, improves quality by ensuring proper alignment of the primary disconnect members 50 and enables future maintenance and repair to be accomplished from the front side of an enclosure 10.

For purposes of this disclosure, the term “coupled” means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components or the two components and any additional member being attached to one another. Such joining may be permanent in nature or alternatively may be removable or releasable in nature

Thus, there is provided an arrangement of components in an electrical equipment enclosure having multiple phase electrical power. The foregoing description of embodiments have been presented for purposes of illustration and description and is not intended to be exhaustive to the precise forms disclosed and modifications and variations are possible in light of the above teaching and may be acquired by practice of the invention. The embodiments are chosen and described in order to explain the principles and practical application to allow one skilled in the art to utilize the alignment and arrangement of components in various embodiments and various modifications that are suited to the particular use contemplated. It is intended that the scope of the arrangement of components and methods for assembly and maintaining primary disconnect members be defined by the claims appended hereto and their equivalents.

What is claimed is:

1. An arrangement of components in a switchgear enclosure having multi-phase electrical power run-in and run-back bus bars and a circuit breaker, the arrangement configured to provide interchangeable modularity of components, the arrangement of components comprising:
a run-in mounting base including a primary disconnect member for each electrical phase; and
a run-back mounting base including a primary disconnect member for each electrical phase, wherein the run-in mounting base and run-back mounting base are configured to interchange the line and load side of the circuit breaker.

2. The arrangement of claim 1, including a bridge coupled to one of the run-in mounting base and run-back mounting base, with the bridge configured to position each primary disconnect member for alignment with the circuit breaker.

3. The arrangement of claim 1, wherein each primary disconnect is configured with two branches for each electrical phase.

4. The arrangement of claim 1, wherein each primary disconnect member is removably coupled to the run-in or run-back bus bars with fasteners.

5. A method for assembling and maintaining a primary disconnect in a switchgear enclosure having a circuit breaker mounting base and one of a run-back bus bar and a run-in bus bar mounted through an orifice in the mounting base, the method comprising the steps of:
a. providing alignment notches in the mounting base;
b. providing an alignment bridge having an alignment tab configured to engage the alignment notch and mounting the bridge in the alignment notch;
c. providing a primary disconnect bus;
d. positioning the primary disconnect bus against the alignment bridge to align the primary disconnect bus front to back and adjacent to the run-back bus bar or run-in bus bar to align the primary disconnect bus side to side;
e. connecting the primary disconnect bus to the run-back bus bar or run-in bus bar with a fastener to aligned the primary disconnect bus top to bottom;
wherein the assembly and maintenance of the primary disconnect is performed at the front of the switchgear enclosure.

6. The method of claim 5, including the steps of repeating steps b-e for each run-back bus bar or run-in bus bar of each phase in the mounting base.

7. The method of claim 6, wherein the run-back bus bar or run-in bus bar for each phase is composed of a plurality 6f individual bus bars and the fasteners are configured to couple each individual bus bar in each phase to the primary disconnect bus.

8. A method for assembling and maintaining a primary disconnect in a switchgear enclosure having a circuit breaker mounting base and one of a run-back bus bar and a run-in bus bar mounted through an orifice in the mounting base, the method comprising the steps of:
a. providing alignment ribs in the mounting base;
b. providing a primary disconnect bus, with the primary disconnect bus having two branches and defining rib notches;
c. positioning the primary disconnect bus in the mounting base to engage the alignment ribs with the rib notches to align the primary disconnect bus front to back and adjacent to the run-back bus bar or run-in bus bar to align the primary disconnect bus side to side;
d. connecting the primary disconnect bus to the run-back bus bar or run-in bus bar with a fastener to aligned the primary disconnect bus top to bottom;
wherein the assembly and maintenance of the primary disconnect bus is performed at the front of the switchgear enclosure.

9. The method of claim 5, including the steps of repeating steps b-d for each run-back bus bar or run-in bus bar of each phase in the mounting base.

10. The method of claim 9, wherein the run-back bus bar or run-in bus bar for each phase is composed of a plurality of individual bus bars and the fasteners are configured to couple each individual bus bar in each phase to the primary disconnect bus.
